(19) United States
(12) Patent Application Publication
(10) Pub. No.: US 2024/0040993 A1
(43) Pub. Date: Feb. 8, 2024

(54) ROBOTIC LIVESTOCK GRAZING APPARATUS AND METHOD

(71) Applicant: Greenfield Robotics Corporation, Cheney, KS (US)

(72) Inventor: Clinton W. Brauer, Cheney, KS (US)

(73) Assignee: Greenfield Robotics Corporation, Cheney, KS (US)

(21) Appl. No.: 18/266,255

(22) PCT Filed: Jan. 20, 2022
(86) PCT No.: PCT/US2022/013178

§ 371 Date: Jun. 8, 2023

Related U.S. Application Data
(60) Provisional application No. 63/140,008, filed on Jan. 21, 2021.

(51) Int. Cl. A01K 3/00; A01K 7/02; A01K 29/00

(52) U.S. Cl. CPC A01K 3/001; A01K 7/027; A01K 29/005

(57) ABSTRACT

A livestock grazing control robotic system provides a movable livestock enclosure than can travel over uneven terrain allowing livestock to graze over different areas, enabling rotational grazing in a cash crop farmland during non-crop time periods. The system includes an enclosure or pen defined by a fencing mechanism. The fencing mechanism is supported by a movable chassis that includes a drivetrain system. The fencing mechanism includes a ground-clearance portion that flexibly covers the area between the chassis and the uneven ground, preventing animals from entering or exiting the enclosure and that can be raised and lowered on command to enable moving of the enclosure. The fencing mechanism may hold water for watering livestock. The system further includes a control module and a power supply that enable autonomous movement of the enclosure according to a grazing plan. The system may receive water and be towed by a water delivery vehicle.

### CROSS-REFERENCE TO RELATED APPLICATIONS

This application claims the benefit of U.S. Provisional Patent Application No. 63/140,008, filed Jan. 21, 2021, which is hereby incorporated by reference in its entirety.

### BACKGROUND

This disclosure generally relates to livestock feeding in farming operations, and more specifically to a system and process for robotic livestock grazing control.

There are over 250 million acres of cropland in the United States. Most of this acreage is used to raise one cash crop per year, such as corn or soybean. During the time of the year when the cash crop is not growing, the land still requires maintenance yet it is not productive. Some farmers choose to plant cover crops and allow livestock grazing in their land during these periods in order to generate income while the cash crops are not producing.

Cover crop planting and livestock grazing practices beneficially increase the fertility of the soil, can reduce or offset costs, and can provide time savings in livestock feeding, providing an overall better performance for the cash crop farming operation. The cover crop itself can enrich the nutrients in the soil through the organic matter the roots provide in the soil. In addition, the grazing process introduces nutrient-rich manure into the soil, further fertilizing it. Further, the use of cover crop grazing in livestock farming reduces the needs and associated costs of harvested feed, lowering labor costs and increasing the grazing time available for livestock each season. The grazing process also leverages the livestock's own habits to fertilize, self-feed, and act as a form of weed control for the non-producing cropland. In addition, this process can also produce grassfed meat, which can demand higher prices in the market. Feeding animals grass is much lower cost than feeding them grains. Thus, cover crop grazing results in additional revenue per acre, better cropland, and decrease fertility and weed control costs.

However, most cropland does not have some of the basic features required for livestock control, such as fencing and gates. Installing fencing is expensive and once installed, maintenance can also be expensive and time consuming. Further, the livestock fencing may be incompatible with the cash crop farming operations, for example due to interference with farming machinery, possibly requiring its removal and installation each year. Moreover, some farmers use rotational grazing to minimize the potential negative impacts of grazing on the cropland, such as soil compaction, high animal density areas, etc., and this rotation process can be labor-intensive and add costs. For example, the system of paddocks typically used to allow animals to move from area to area can be labor intensive and provide opportunities for animals to escape. That said, rotational grazing can have additional benefits. For example, rotational grazing of cover crops may be used to increase carbon fixation into the soil, which may be used as a carbon offset measure, potentially resulting in additional revenue per acre maintained. In addition, if animals are grazed to stay away from the same area for at least 60 days, not allowed to eat the cover crop or weeds to the ground, then the need for antibiotics/vaccines may be reduced or eliminated altogether, improving meat quality, reducing costs, and increasing revenue.

Thus, what is needed is a livestock grazing approach that addresses the deficiencies of the prior art while providing the benefits of the rotational grazing practices.

### BRIEF SUMMARY

According to various embodiments of the present invention, a method and apparatus are provided for the control of livestock grazing operations. The system and methods according to this disclosure provide a livestock grazing approach that can drive the industry towards the deprecation of animal feedlots, reduce deforestation, and to increase the availability of grassfed meats, possibly making them more readily available than grainfed counterparts. This will improve human health and dispel the notion that plant-based foods are required for saving the planet.

An apparatus for the control of livestock grazing may include: a fencing mechanism, including a plurality of fencing members flexibly attached to each other and defining a livestock enclosure; a chassis mechanically supporting the fencing mechanism; a drivetrain system mechanically attached to the chassis for moving the apparatus from one grazing area to another; a clearance fencing section, attached to the chassis and securing an area of the enclosure between the chassis and a surface of an area to be grazed, the clearance fencing section configured to be mechanically lifted and dropped to enable the apparatus to move; and a control module, the control module configured to control the drivetrain system to autonomously move the apparatus according to a grazing plan, the control module further configured to raise the clearance fencing section prior to initiating motion and to lower the clearance fencing section upon reaching a desired grazing location. In some examples, the fencing members are configured to fold along flexible attachments to reduce the width of the apparatus so as to enable travel over a highway. In some examples, the apparatus may include a power supply module coupled to the drivetrain system and the control module for providing power. In some examples, the power supply module includes a solar panel. In some examples, the apparatus may include a watering module for providing water to the livestock, the watering module including an antifreeze mechanism configured to be responsive to a temperature sensor detecting a temperature capable of causing water to freeze.

In some examples, the apparatus may include a sensor module, the sensor module communicatively coupled to the control module and comprising at least one camera for capturing a video feed. In some examples, the video feed is of the livestock within the livestock enclosure. In some examples, the video feed is of an area surrounding the livestock enclosure. In some examples, the control module includes video processing software for analyzing the video feed, the video processing software configured to identify animals within the enclosure. In some examples, the control module also may include: video processing software for analyzing the video feed, the video processing software configured to identify predators surrounding the enclosure; threat detection software for generating a notification upon detection of a predator in the video feed; and a communications module, for transmitting the notification to a remote user. In some examples, the control module also may include: livestock monitoring software for monitoring a feature of an identified animal within the enclosure; and a communications module, for transmitting data representative of the feature and the identified animal to a remote database for storage.

In some examples, at least one of the plurality of fencing members is configured to hold water. In some examples, the at least one of the plurality of fencing members is configured to provide said water to a watering module. In some examples, at least one of the plurality of fencing members is configured to be attached to a vehicle, the vehicle configured to pull the apparatus to or from the desired grazing location. In some examples, the vehicle is further configured to detach from the at least one of the plurality of fencing members and to be driven to a different location. In some examples, the vehicle is configured to deliver water to the apparatus.

### BRIEF DESCRIPTION OF THE SEVERAL VIEWS OF THE DRAWINGS

FIG. 1 illustrates an exemplary livestock grazing control robotic apparatus, in accordance with one or more embodiments.

FIG. 2 is a diagram illustrating a side view of an exemplary drivetrain, in accordance with one or more embodiments.

FIG. 3 is a diagram illustrating an isometric view of an exemplary drivetrain set, in accordance with one or more embodiments.

FIGS. 4A-4C are diagrams illustrating top views of exemplary livestock grazing control systems with different configurations, in accordance with one or more embodiments.

FIG. 4D is a diagram of an exemplary flexible join, in accordance with one or more embodiments.

FIG. 5 is a diagram illustrating a side view of an exemplary livestock grazing control system, in accordance with one or more embodiments.

FIGS. 6A-6B are diagrams illustrating portions of an exemplary fencing mechanism for a livestock grazing control robotic apparatus, in accordance with one or more embodiments.

FIG. 7 is a diagram illustrating a top view of another exemplary livestock grazing control system, in accordance with one or more embodiments.

FIGS. 8A-8B are diagrams illustrating top views of exemplary livestock grazing control systems with a water delivery vehicle, in accordance with one or more embodiments.

FIG. 9 is a flow diagram illustrating a method for watering and movement of a livestock grazing control system, in accordance with one or more embodiments.

The figures depict various example embodiments of the present disclosure for purposes of illustration only. One of ordinary skill in the art will readily recognize form the following discussion that other example embodiments based on alternative structures and methods may be implemented without departing from the principles of this disclosure and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The above and other needs are met by the disclosed methods and systems for automated robotic control of livestock grazing operations.

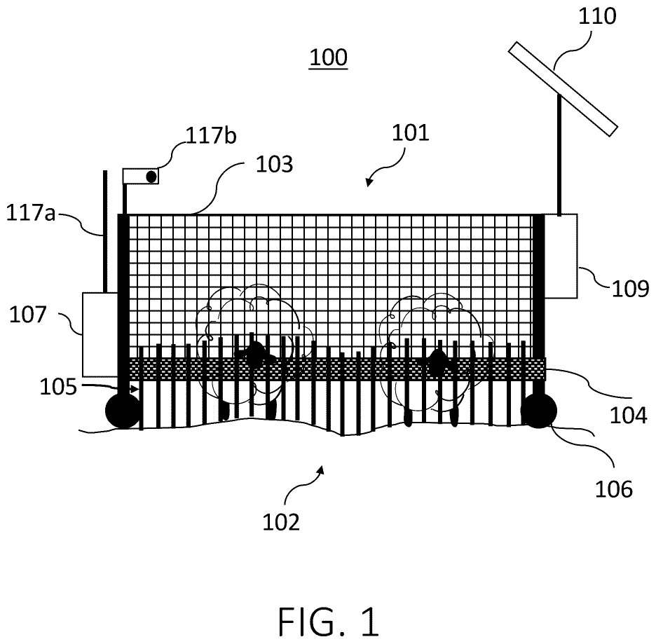

Referring now to FIG. 1, a diagram of a livestock grazing control robotic system is provided according to embodiments. The system 100 provides a movable livestock enclosure 101 than can travel over uneven terrain 102 allowing livestock to graze over different areas, for example, enabling rotational grazing in a cash crop farmland during non-crop time periods. The system 100 includes an enclosure or pen defined by a fencing mechanism 103. The fencing mechanism 103 is supported by a movable chassis 104 that includes a drivetrain system 106. The fencing mechanism includes a ground-clearance portion 105 that flexibly covers the area between the chassis and the uneven ground, preventing animals from entering or exiting the enclosure. The system 100 further includes a control module 107 and a power supply 109.

The control module 107 includes hardware and software for controlling the system as further described below. While, for exemplary purposes the system 100 is described with a primary module 107, any number of hardware or software modules, alone or in combination with other devices, can be provided within the scope of the invention. For example, in one embodiment, modules may be software modules or submodules implemented with a computer program product comprising computer-readable media containing computer program code, which can be executed by one or more computer processors for performing any or all of the steps, operations, or processes described below. This control module 107 may be specially constructed for the system 100 disclosed herein, and/or it may comprise one or more general-purpose computing devices or systems selectively activated or reconfigured by computer programs stored in the computers to perform the functions described herein. Such computer programs may be stored in a non-transitory, tangible computer readable storage medium, or any type of media suitable for storing electronic instructions, which may be coupled to a computer system bus or otherwise accessible to memory coupled to a processor for execution of the electronic instructions. Such a system bus can be interfaced to other hardware modules, controllers, and the like, as is known in the art.

According to embodiments, the control module 107 can include communications systems 117a and sensor systems 117b. The control module 107 also includes processing modules, including hardware, memory, and software, that execute programming instructions for different functionalities enabled in software. The functionality provided by the control system can vary in different embodiments depending on the desired features to be provided. By way of example, control system can provide autonomous drive and location control, two-way data communications, weather monitoring functions, livestock monitoring and tracking functions, mechanical control functions for system components, power control functions, security functions, and the like.

In one embodiment, control module 107 includes communications systems 117a comprising global positioning system (GPS) signal reception and processing and two-way cellular communications. Additional or alternative communications capabilities can be incorporated in communications system 117a as may be desired for particular applications, including for example, Wi-Fi, Satellite, or other wireless or even wired communications. For example, if a system is installed close to a telephone line or poll, a POTS interface wired to the telephone line can be provided. While the control module 107 may include input/output capabilities to provide a user interface to software modules for the system, such as a display, keyboard, mouse, etc., in embodiments, the two-way data communication capability can allow for a wireless user interface, such as a remote software application on a personal computer, smartphone, or other mobile device.

The control module 107 includes motor controllers for controlling the drivetrain system 106. GPS signals are used by control module 107 to determine the location of the system and for navigating according to desired patterns. Routing software executed in processing modules interfaced with the motor controllers, the communications systems 117a, and other sensor modules 117b, allow the system 100 to autonomously move in any direction desired. The routing software can receive as input GPS coordinates, camera signals, radar/lidar signals, proximity signals, and the like, to determine direction, speed, and desired stopping locations as may be provided by its instructions and settings. For example, via two-way data communications, the routing software can receive instructions detailing the route or displacement desired, for example, to cover a certain area of farmland over desired period of time. The routing software provides not only control over location but also speed and time to remain at each desired location, allowing a user to provide a detailed plan for grazing control over a period of time. For example, in some embodiments, the system 100 may be programmed to continuously move at a very slow pace over a given area, or may be programmed to move periodically from a patch of land to another, where the patches slightly overlap, or may be programmed to move in other pattern as may be desirable to a given user or farmer. The routing software can also provide a manual mode, allowing a user to remotely control the movement of the system 100. The routing software can be programmed in any computer language as is known in the art.

The system 100 is powered by power module 109. In one embodiment, as illustrated, power module 109 may include a solar power system 110. However, in other embodiments other sources of power may be used, such as fuel-based systems (generators, gas/diesel engines, or the like) or possibly wind turbines. The power module 109 may include batteries to store and supply power to other system components, including for example, drivetrain system 106, control module 107, and other system components. In embodiments, as part of the power module 109, a grounding rod (not shown) may be provided for electrical grounding and as a safety measure. The grounding rod electrically attaches to all the metal components of the system 100 to provide an electrical ground, for example, for solar power system 110 and all electrical components, including, for example, electric fencing or the like. The grounding rod can also protect against electrical surges, such as shorts in the power module 109 due to malfunction or accidents and due to outside sources, such as lighting.

According to embodiments, control module 107 includes a sensor system 117b with one or more cameras. For example, sensor system 117b may include one or more digital cameras, depth sensing cameras, infrared cameras, night vision cameras, or the like. In some embodiments, cameras, such as for example wireless 1080p, 4K, 8K video cameras, in sensor system 117b may be provided. In one embodiment the cameras may be distributed around the top perimeter of the fencing mechanism. However, the location of the cameras can vary depending on the intended purpose and multiple locations for cameras for different purposes can also be provided in different embodiments. For example, for weather tracking purposes, temperature, humidity, rainfall, and wind-speed sensors can be provided along the upper perimeter of the fencing mechanism. Other sensors may be provided along the bottom perimeter, such as optical recognition sensors and probes to measure soil metrics, including, for example, soil health, nutrient density, pH, alkalinity, and fertilizer content. These metrics can be used to predict soil health and to complement the function of other module, such as weeding/planting modules further described herein. As other examples of camera locations in different embodiments, animal tracking cameras can be located around or within the enclosure facing the livestock, while security or drive control cameras/sensors can be placed on the outside of the chassis or around the fence perimeter facing out of the enclosure. The cameras may be wired or wirelessly connected to a video controller in control module 107.

Software for operation of the cameras may include image processing capabilities for recognition of different features in the video feeds. Automatic notifications/alarms, including text messages, email, or the like, can be set up to alert a user of any abnormal situation that may be detected. For example, in one embodiment face recognition software is provided capable of recognizing each individual animal in the livestock within the enclosure. Information about each animal can be maintained in a database, locally or remotely form the enclosure and accessible via data communications. This feature allows the tracking of multiple variables and properties of individual animals without the need for tags, essentially from birth through butchering. Different options for the storage of the animal tracking information can be provided. For example, in one embodiment, the animal tracking information, including vitals, health parameters, and image/video taken at periodic intervals is logged on a public or private blockchain system. The blockchain system provides detailed data to industry partners and consumers on exactly how the animal was raised, for example via the image/video data and other sensor data logged in an audit trail. This approach can provide evidence of food-related labeling or claims, such as, “grass-fed,” “organic,” “free-range,” or the like, providing an evidence-based source of trust for these claims.

The camera tracking system can monitor each animals' movement and health. For example, image processing algorithms can examine changes in body shape/volume over time to determine whether any of the animals in the pen are not growing as expected and possibly issue an alert if desired. For additional health monitoring, heat sensing cameras or other sensors can be provided that may be able to detect abnormal body temperature fluctuations in the animals. Further, a scale or other weight sensor can be integrated into the system under the monitor of another video feed. Using image processing and other software heuristics (e.g., maximum weight thresholds for a given breed), the software can determine if a single animal is on the weight sensor and can recognize the individual animal, such that the weight of the animals may be tracked and stored in the database. In some embodiments, fence-contact sensors, such as accelerometers, capacitive touch sensor, or the like, are provided to sense how often the animals in the pen “touch” the fence. For example, the frequency of fence touching or bumping in sheep is understood to provide one sign of hunger. These sensors can be attached to the fence or the frame.

As another example, the face recognition software can also be used for security purposes. Authorized personnel approaching the system 100 can be recognized using the face recognition software and an-authorized individuals can be detected, possibly resulting in an alert/alarm being issued. The image recognition software can also be used to identify or detect other threats, including for example presence of predators (coyotes, foxes, etc.) or even detect any animals that try to or manage to escape from the pen. Additional sensors can also be used, such as heat imaging or night vision cameras that can be used or additionally leveraged to detect the presence of animals or other threats. As noted above, alerts or notifications can be sent to a remote user via two-way communications, including video or images of the analyzed scene such that a remote user can visually verify or confirm the threat. Further, remote access to the video feeds can also be provided in embodiments of the system 100.

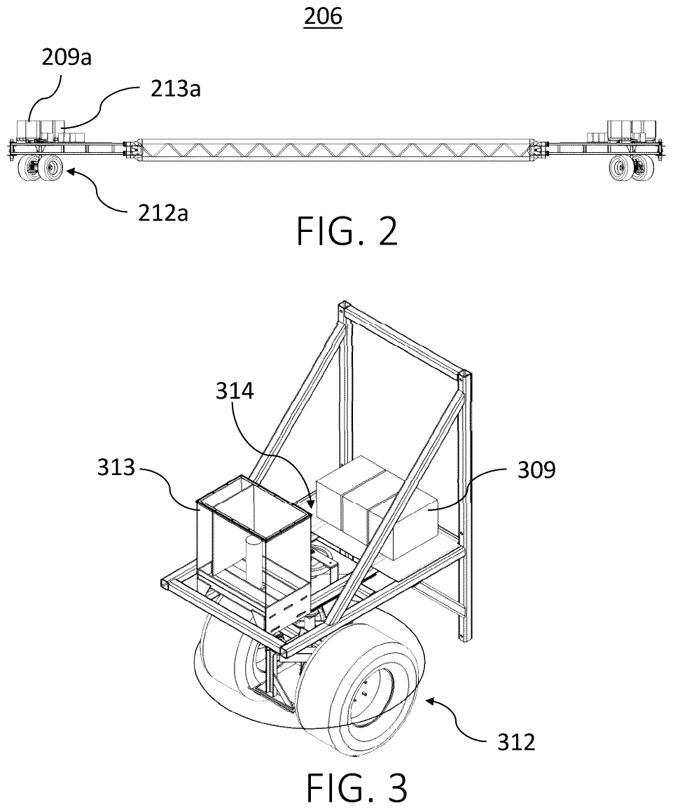

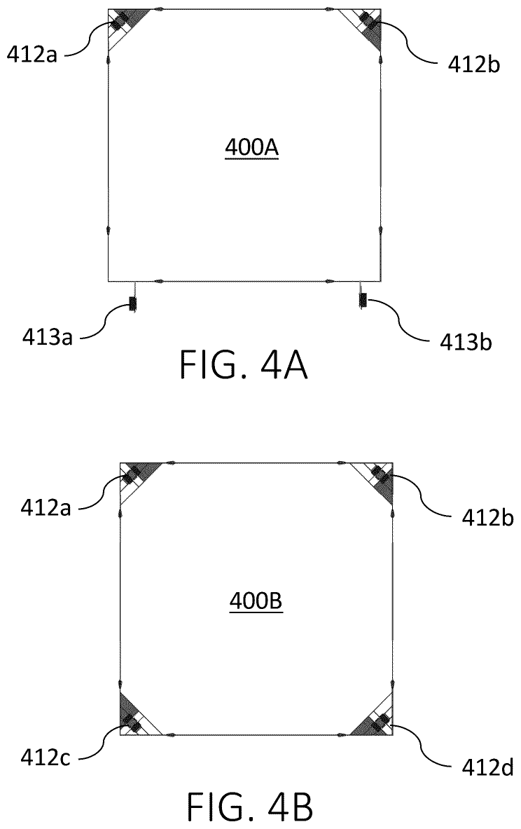

Now referring to FIG. 2, a diagram of a side view of a drivetrain according to embodiments is provided. In these embodiments, the drivetrain system 206 includes sets of wheels 212, steering and motion modules 213 and power modules 209. While one set is identified in FIG. 2 for illustrative purposes, two or more of these sets may be included in a drivetrain system 206 depending on the embodiments. As illustrated in FIG. 2, the power supply system, illustrated in FIG. 1 as 109, may be distributed in different modules 209a . . . 209a around the system in different embodiments. In the embodiments illustrated by FIG. 2, each drivetrain system set includes its own power supply submodule 209a, for example a set of lithium-ion or lead-acid batteries or battery packs. FIG. 3 provides an isometric view diagram of a close-up of a drivetrain set. In this embodiment, power supply module 309 includes a set of batteries that power an electric motor 313 mechanically coupled to steering and suspension mechanism 314. The steering and suspension mechanism 314 couple the wheels 312 to motor 313. Motor 313 is communicatively coupled, via wired or wireless circuitry, to the control module (not shown). Depending on the intended application, different embodiments can be provided with different wheel size and/or type. The size and type of wheel will allow for navigation in different types of terrains. For example, in some embodiments, for substantially flat cash crop farmland (cropland) smaller wheels are preferred as the ground clearance is smaller, minimizing the potential for animal escape and/or predator intrusion. In other embodiments, for more uneven pasture terrain, bigger wheels may be desired.

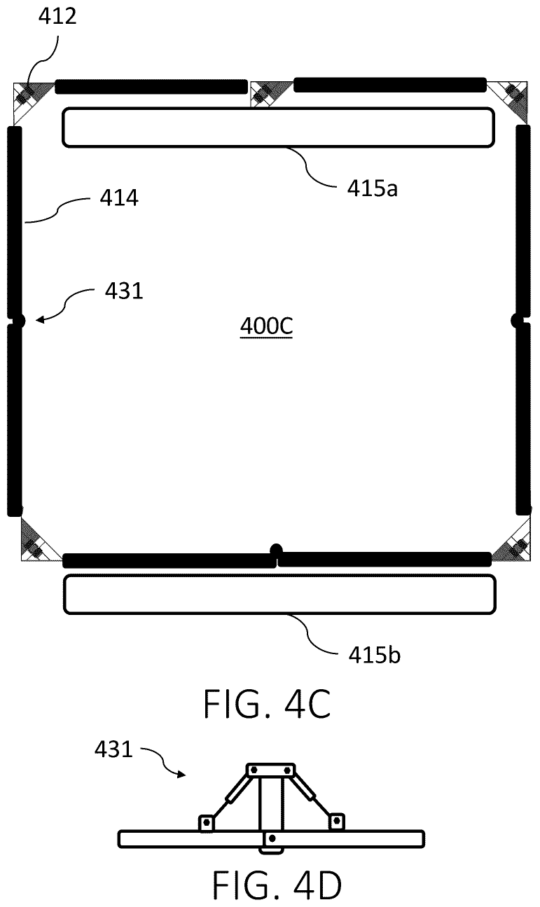

Now referring to FIG. 4A and FIG. 4B, top-view diagrams of exemplary livestock grazing control systems with different configurations according to embodiments are provided. FIG. 4A illustrates embodiments of livestock grazing control system 400A with front-wheel-drive capabilities. In these embodiments, motorized drivetrain sets 412 are provided along the front side of the system. As illustrated, in this embodiment two motorized sets 412a and 412b are included to provide the motive force to move around the exemplary livestock grazing control system 400A. However, different numbers of motorized wheels 412 can be provided in different embodiments. Along the back of the livestock grazing control system 400A non-motorized trailing wheels 413 are provided. In this example, two wheels 413a and 413b are show for illustrative purposes but different numbers of wheels can be provided according to embodiments. For example, the number of wheels may vary depending on the size of the enclosure. In embodiments, the enclosure may be defined by fencing mechanisms including panels of different sizes. For example, enclosures may be dimensioned at 40 feet by 40 feet, 60 feet by 60 feet, or in any other area size or shape as may be desired for the number and type of livestock.

FIG. 4B illustrates embodiments of exemplary livestock grazing control system 400B with all-wheel-drive capabilities. In these embodiments, at least four of the drivetrain sets are motorized drivetrain sets 412. These livestock grazing control systems 400B provide additional movement flexibility and finer control for locating the grazing system within a given area of land. For example, livestock grazing control system 400B is “strafing capable” so that it can move in all directions, front, back, left or right, at any given time. This finer control can allow the system to navigate over more diverse types of surfaces, possibly avoiding rocks, sinkholes, watering structures, and other obstacles that may be found in the land.

Now referring to FIG. 4C, a top-view diagram of a system with a different configuration is provided according to embodiments. In this livestock grazing control system 400C, fencing panels 414 are illustrated. The fencing panels 414 may be, for example, 20-30 ft sections. The fencing panels are joined with flexible joins 431 which may allow for some vertical sliding between sections to account for uneven terrain levels. FIG. 4D provides a diagram of an illustrative flexible join 431 according to embodiments. In other embodiments, flexible joins 431 can allow the fencing sections to fold as further illustrated below. System 400C is illustrated as an all-wheel-drive embodiment, with motorized wheels 412. However, front-wheel-drive or back-wheel-drive embodiments are also possible. In addition, system 400C illustrates embodiments with additional sets of motorized wheels 413, for example, showing three sets along the front of the system 400C. In some embodiments, the system can include optional accessory modules 415. For example, system 400C includes a watering module 415a and a weeding/planting module 415b. To account for the additional weight of the watering module 415a, system 400C includes a central motorized wheel along the front side. It should be noted that additional wheels need not be motorized in other embodiments while still maintain the desired type of drivetrain, all-wheel-drive, front-wheel-drive or back-wheel-drive.

Watering module 415a allows for the storage and dispensing of water for the livestock. Watering module 415a includes storage tanks and water dispensing mechanism that may be monitored and controlled by control module. Control module may monitor the water available for drinking in drinking vessels and add water from storage tanks as needed. Storage tanks and/or drinking vessels can also include anti-freeze mechanisms, e.g., heat sources, mechanical agitators, self-stirring mechanisms, or the like, which may also be controlled by control module based on ambient temperature to prevent freezing of the water. For example, in some embodiments the watering modules 415a self-stir overnight based on temperature reads, and are driven off the batteries, to keep the water from freezing during sub-freezing conditions. In some embodiments, the watering module 415a may be attached to the fencing panels 414, being weight-distributed evenly across the frame of the overall system 400.

Weeding/planting module 415b allows the system 400C to be configured to plant additional cash or cover crops by either casting seed in front or no-till planting behind it. The system 400C also can be configured to have “grassbot” functionality (as further described in co-pending U.S. Patent Application No. 63/104,798, “Robotic Weed Control Apparatus and Method” filed on Oct. 23, 2020, which is incorporated herein by reference) and a planter behind it to eliminate the need for any herbicides. Thus, after a particular area of cropland is grazed for a desired period of time, the system 400C can move over the area to a next area and plant new cash or cover crops behind it as it moves over the recently grazed area. This not only allows for rotational grazing but also automates the process of planting cash crops or additional cover crops to continue the rotational grazing process.

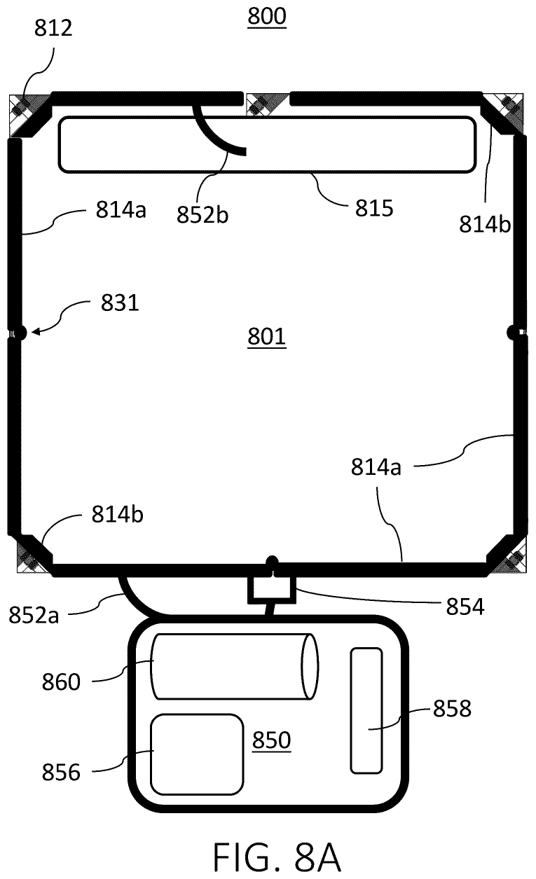

Referring back to FIG. 1, according to embodiments, control module 107 includes a fencing mechanism controller that controls different aspects of the fencing mechanism 103. For example, in embodiments, fencing mechanism controller in control module 107 may lift the ground-clearance portion 105 of the fencing mechanism 107 prior to moving the system 100 and then lower the ground-clearance portion 105 once the next location has been reached. In some embodiments in which a grounding rod is provided, this mechanism can also be used to similarly lift and lower the grounding rod when moving the system 100. However, grounding rod control may be provided separately. In embodiments, fencing mechanism controller may also include electrifying functionality to selectively electrify all or portions of the fencing mechanism 103 as may be desired. This features allow the system to move from one are to another while maintaining the livestock inside under control. Further, monitoring system can be used to prevent an animal from escaping while moving, by for example temporarily lowering or simply moving sections of the ground-clearance portion through which an animal may try to escape. This may scare off the animal and prevent the escape while continuing to move. In embodiments, fencing mechanism controller may also control the folding of the fencing mechanism 103 as further described below with reference to FIG. 7.

As illustrated in FIG. 1, in embodiments, the fencing mechanism can comprise panels of steel, aluminum, or other fencing material to secure the enclosure. As illustrated with reference to FIG. 4A-FIG. 4C, these panels can be of any desired dimension, length and/or height, and be flexibly and mechanically joined into a secured perimeter fence. The fencing mechanism is supported by a chassis, such as, for example and aluminum truss structure, steel structure, or the like. Below the chassis a ground-clearance section is flexibly and removably enclosed by another portion of fence 105. For example, in embodiments, a post fencing system is provided to cover this ground-clearance section (as further described below).

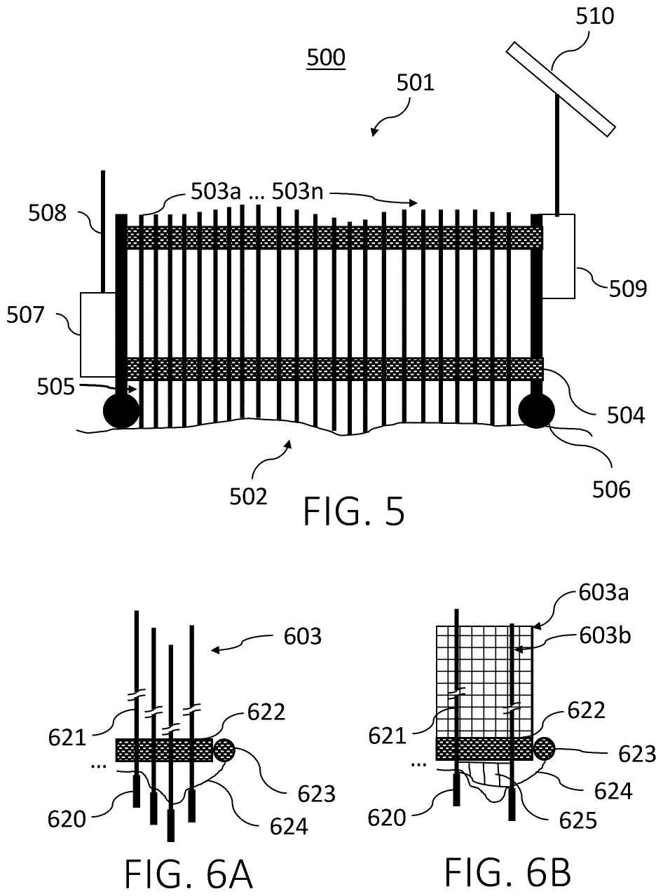

FIG. 5 provides a diagram illustrating a livestock grazing control system according to embodiments. The system 500 is similar to the system 100 of FIG. 1. In these embodiments, however, instead of separate fending panels, the fencing mechanism 503 is provided by the same type of fencing provided for ground-clearance section 505. A number of posts 503a . . . 503n are slideably attached to a chassis 505 with an upper and lower portion. The posts 503 are inserted through holes in the upper and lower portions of the chassis and can move up or down to adjust to the contour of the underlying terrain 502. This provides a fully enclosed pen that prevents animals from entering or exiting the pen regardless of the unevenness of the terrain below.

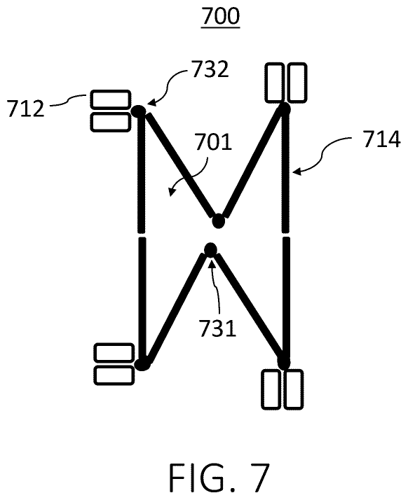

FIG. 6A is a diagram that provides an illustration of a portion of this fencing mechanism. The set of posts 603 can be of any desired length to cover the desired height of the enclosure (the upper portion of the chassis is not shown). At the bottom side, the posts 603 can slide up or down through chassis (lower chassis 622 is shown) and include a weighted tip 620. The weighted tip 620, for example a section of steel pipe, can be mechanically attached to a rod 621, such as for example a fiberglass or aluminum rod (but any other material can be used). In order to control the fencing mechanism, in some embodiments a winch 623 is provided. The winch controls a cable 624 which is threaded through each of the poles 603. For example, a wire rope (e.g., 3/16″ steel rope or similar) is threaded at the junction between each tip 620 and rod 612 that when is tightened by the winch 623 lifts all the poles 603 up from the ground to the lower chassis 622. As described above, this process may be under the control of the control module 107/507 to allow moving of the system. The pitch at which the posts 603 are provided can vary depending on the size of animals being enclosed in the pen. For example, in some embodiments, posts at 6 inch spacing may be provided for a sheep and goats. Larger spacing would be adequate in other embodiments, for example for cattle grazing. Similarly, while embodiments are shown with perimeter fencing, additional fencing can be provided in other embodiments, such as fencing along the top and/or bottom of the pen. For example, in a poultry-based embodiment, a top fence can be provided to prevent animals from flying in or out of the enclosure.

FIG. 6B is a diagram that provides an illustration of a portion of the fencing mechanism according to embodiments. As illustrated in these embodiments, on the upper side the fencing mechanism includes posts 603b and fencing panels 603a. These posts 603b are set a larger pitch than that illustrated in FIG. 6A. For example, these posts 603b may be set every few feet (between 2 and 10 feet). Between the posts 603b fencing panes 603a may optionally be provided, for example depending on the type of animal enclosed and/or on the post pitch. Below the lower chassis 622, in these embodiments an electric fencing material 625 is provided between the posts 603b. As noted above, this electric fencing material can be selectively electrified under the control of control module 107/607 using power module 509, including, for example, batteries and grounding rod. It should be noted that any of the fencing mechanism portions may include electric fencing materials that can optionally be controlled as noted above.

Referring now to FIG. 7, a top-view diagram of an exemplary livestock grazing control system is provided according to embodiments. In these embodiments, the enclosure 701 is collapsible to allow it to travel over paved or unpaved roads to move from field to field. For example, the fencing panels 714 in this livestock grazing control system 700 are joined by foldable joins 731 that allow the panels to bend inward (or outward) in order to change the size of the enclosure. In this embodiment, an all-wheel-drive embodiment, the motorized wheels 712 on one side of the enclosure can rotate sideways while pushing the sides of the enclosure towards each other. The wheels on the other side remain static preventing the other side from sliding. Flexible joins 731 can be controllably unlocked by control module to allow the folding operation. This folding would enable the livestock grazing control system 700 to be of a width compatible with highway travel, e.g., less than 8 feet in width. In embodiments, drivetrain sets 712 (whether motorized or not) can be set on an “unlocked” mode to allow for towing. Not only does this allow highway travel, but also allows towing if necessary in other situations, for example, if the system becomes stuck in mud, sand, or the like. In some embodiments, if the system becomes broken or stuck, a hitch system can be provided that can be connected to a tractor, UTV or vehicle for towing. In the “unlocked” mode, the drive systems can “free wheel” so the towing can happen at a low speed without drive system damage.

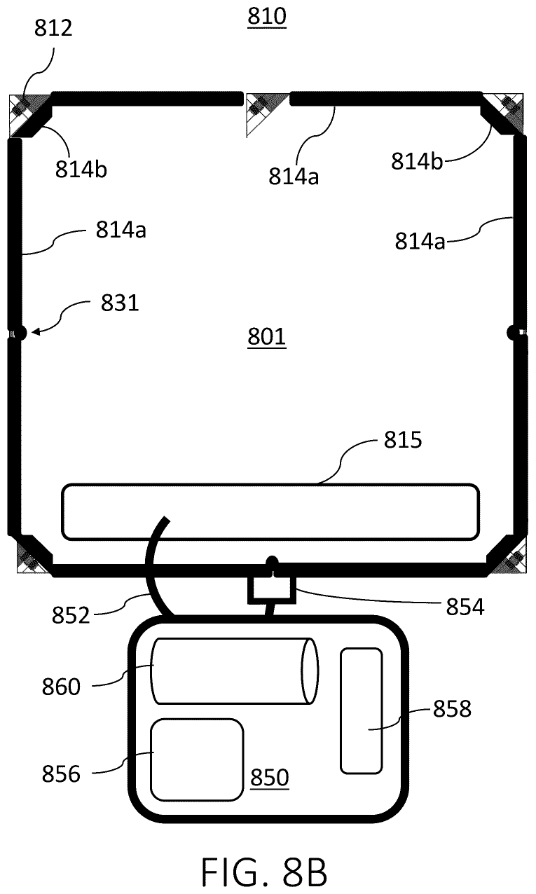

In many of the embodiments described herein, water for a watering module, as described herein, may be delivered to the watering module by a water delivery vehicle. In some examples, water for a watering module, as described herein, may be carried through portions of the fencing mechanism (e.g., fencing panels, panes, posts, or other fencing portions, as described herein) to be provided to the watering module. FIGS. 8A-8B are diagrams illustrating top views of exemplary livestock grazing control systems with a water delivery vehicle, in accordance with one or more embodiments. In FIG. 8A, system 800 includes livestock grazing control system 801 and water delivery vehicle 850. Livestock grazing control system 801 may comprise the same or similar components to other livestock grazing control systems described herein. For example, as shown, livestock grazing control system 801 may include drivetrains 812, fencing elements 814a-b, flexible joins 831 and a watering module 815. Drivetrains 812 may include some or all of the elements described herein for motorized drivetrain sets. In some examples, fencing elements 814a-b may include lightweight hollow pipes (e.g., acrylonitrile butadiene styrene (ABS), polyvinyl chloride (PVC)) in various configurations (e.g., combinations of straight, bent, or joint connecting segments) capable of holding (e.g., storing) water, carrying water to watering module 815 (e.g., from water delivery vehicle 850 or other water source), and fencing in livestock. In some examples, fencing elements 814a-b may be configured to store water, as well as to cause the water to be heated to prevent freezing. In some examples fencing elements 814a-b may comprise a combination of fencing elements in addition to lightweight hollow pipes configured to carry and hold water, such as vertical or semi-vertical posts, panels, and other fencing elements described herein. Flexible joins 831 may enable fencing elements 814a-b to be folded for ease of storage, similarly to system 700 in FIG. 7.

Water delivery vehicle 850 may comprise a utility terrain vehicle, all terrain vehicle, or other suitable vehicle for temporary or removably attaching to a side of, and pulling, towing, and otherwise moving, livestock grazing control system 801. For example, water delivery vehicle 850 may include electric drive motor 856, electric shifting actuator 858, and water container 860. Water delivery vehicle 850 may be configured to be driven, either by an onboard driver, a remote driver, or autonomously, to and from locations with or without a livestock grazing control system in tow. For example, water delivery vehicle 850 be driven to a side of livestock grazing control system 801, attached to a fencing element, and once attached, driven to pull livestock grazing control system 801 in a given direction (e.g., toward another grazing location). Water delivery vehicle 850 also may disconnect (i.e., detach) from the fencing element, be driven to a water source (not shown) to load water container 860 (e.g., by water transfer mechanism 852a), and driven to return to a side of livestock grazing control system 801 to reconnect and/or provide water to watering module 815.

Water delivery vehicle 850 may include a removable attachment mechanism 854 and water transfer mechanism 852a. Attachment mechanism 854 may comprise a hitch or other method of connecting water delivery vehicle 850 to one or more fencing elements 814a-b for purposes of pulling, towing, and otherwise moving, livestock grazing control system 801. In some examples, water transfer mechanism 852a may comprise a pipe or hollow connection, rigid or flexible, and may be connected to a pump (not shown) configured to cause water to flow in a desired direction (e.g., from vehicle 850 to fencing elements 814a-b, from vehicle 850 to watering module 815, from a water source to vehicle 850).

System 810 in FIG. 8B shows another configuration of livestock grazing control system 801 with water delivery vehicle 850, wherein water delivery vehicle 850 is on a side of livestock grazing control system 801 near or adjacent to watering module 815. In this embodiment, water delivery vehicle 850 may be configured to provide water directly to watering module 815 using water transfer mechanism 852 without carrying the water through fencing elements 814a-b. In some examples, livestock grazing control system 801 may include other components described herein, but not shown in FIGS. 8A-8B.

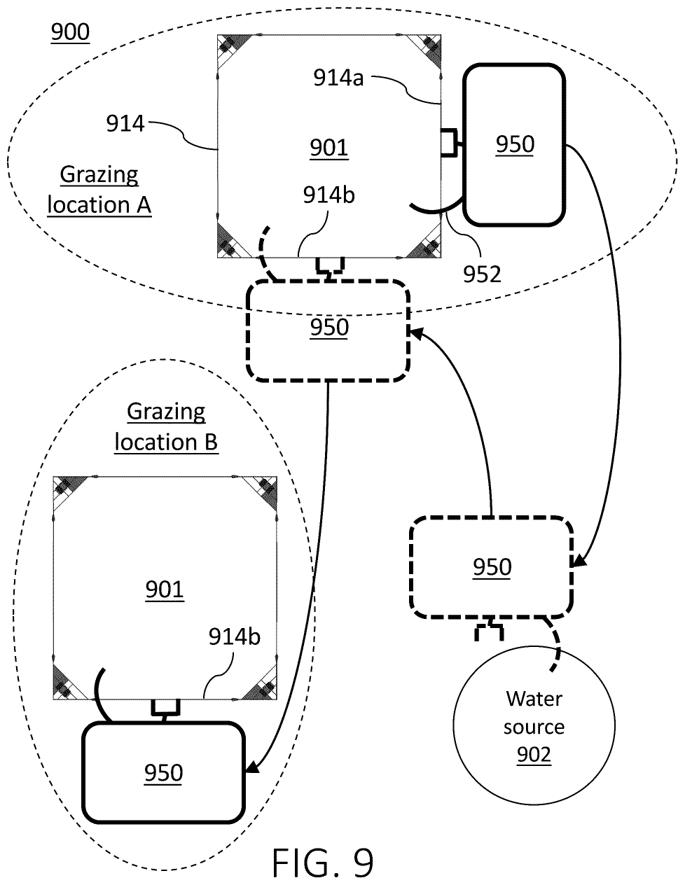

FIG. 9 is a flow diagram illustrating an exemplary watering and movement of a livestock grazing control system, in accordance with one or more embodiments. Diagram 900 includes livestock grazing control system 901, water source 902 and water delivery vehicle 950. Livestock grazing control system 901 operates similarly to other livestock grazing control systems described herein, and may include similar elements, some not shown, including fence 914, a watering module, drivetrain sets, flexible joins connecting parts of fence 914, among other elements. Water delivery vehicle 950 may include similar components to water delivery vehicle 850 and operate similarly. Water delivery vehicle 950 may attach to any side of fence 914 to pull livestock grazing control system 901 in a given direction. Water delivery vehicle 950 also may detach from said side of fence 914, automatically or manually. In an example, while livestock grazing control system 901 is in grazing location A, water delivery vehicle 950 may be attached to fence side 914a and configured to provide water to livestock being penned in by fence 914 (e.g., by a watering module, as described herein) using water transfer mechanism 952. Water delivery vehicle 950 may detach from fence side 914a and may be driven (e.g., by an on board driver, by remote control, or autonomously) to water source 902 to obtain water, driven back to livestock grazing control system 901 to water any livestock penned in by fence 914. Water delivery vehicle 950 may re-attach to fence 914 on fence side 914b to tow livestock grazing control system 901, and thereby move the livestock penned within fence 914, to grazing location B.

In other examples, water delivery vehicle 950 may fill fence 914 and/or a watering module for system 901 with water, detach from system 901, and be driven to another system for watering, with or without a stop at water source 902 in between. In still other examples, livestock grazing control systems 801 in FIGS. 8A-8B and 901 in FIG. 9 may be configured to drive themselves to and from one grazing location to another grazing location without being pulled by a separate vehicle (e.g., using remote or autonomous control of their respective drivetrain sets).

Thus, according to the systems and methods disclosed, a robotic livestock grazing control approach is provided. This approach beneficially allows grassfed livestock, including sheep, cattle and goats, to be maintained, fed, and controlled, with minimal human interaction, reducing the risk of animal/human contagion as well as the labor costs that would otherwise be required. This system allows paddock grazing to scale, without the need for installation and removal of fencing and gates and automatically providing a controllable rotational grazing.

As those in the art will understand, a number of variations may be made in the disclosed embodiments, all without departing from the scope of the invention, which is defined solely by the appended claims. It should be noted that although the features and elements are described in particular combinations, each feature or element can be used alone without the other features and elements or in various combinations with or without other features and elements.

What is claimed is:

1. An apparatus for the control of livestock grazing comprising:
a fencing mechanism, including a plurality of fencing members flexibly attached to each other and defining a livestock enclosure;
a chassis mechanically supporting the fencing mechanism;
a drivetrain system mechanically attached to the chassis for moving the apparatus from one grazing area to another;
a clearance fencing section, attached to the chassis and securing an area of the enclosure between the chassis and a surface of an area to be grazed, the clearance fencing section configured to be mechanically lifted and dropped to enable the apparatus to move; and
a control module, the control module configured to control the drivetrain system to autonomously move the apparatus according to a grazing plan, the control module further configured to raise the clearance fencing section prior to initiating motion and to lower the clearance fencing section upon reaching a desired grazing location.

2. The apparatus of claim 1, wherein the fencing members are configured to fold along flexible attachments to reduce the width of the apparatus so as to enable travel over a highway.

3. The apparatus of claim 1, further comprising a power supply module coupled to the drivetrain system and the control module for providing power.

4. The apparatus of claim 3, wherein the power supply module includes a solar panel.

5. The apparatus of claim 1, further comprising a watering module for providing water to the livestock, the watering module including an antifreeze mechanism configured to be responsive to a temperature sensor detecting a temperature capable of causing water to freeze.

6. The apparatus of claim 1, further comprising a sensor module, the sensor module communicatively coupled to the control module and comprising at least one camera for capturing a video feed.

7. The apparatus of claim 6 wherein the video feed is of the livestock within the livestock enclosure.

8. The apparatus of claim 6, wherein the video feed is of an area surrounding the livestock enclosure.

9. The apparatus of claim 7, wherein the control module includes video processing software for analyzing the video feed, the video processing software configured to identify animals within the enclosure.

10. The apparatus of claim 8, wherein the control module further comprises:
video processing software for analyzing the video feed, the video processing software configured to identify predators surrounding the enclosure;
threat detection software for generating a notification upon detection of a predator in the video feed; and
a communications module, for transmitting the notification to a remote user.

11. The apparatus of claim 9, wherein the control module further comprises:
livestock monitoring software for monitoring a feature of an identified animal within the enclosure; and
a communications module, for transmitting data representative of the feature and the identified animal to a remote database for storage.

12. The apparatus of claim 1, wherein at least one of the plurality of fencing members is configured to hold water.

13. The apparatus of claim 12, wherein the at least one of the plurality of fencing members is configured to provide said water to a watering module.

14. The apparatus of claim 12, wherein the at least one of the plurality of fencing members is configured to cause the water to be heated.

15. The apparatus of claim 1, wherein at least one of the plurality of fencing members is configured to be attached to a vehicle, the vehicle configured to pull the apparatus to or from the desired grazing location.

16. The apparatus of claim 15, wherein the vehicle is further configured to detach from the at least one of the plurality of fencing members and to be driven to a different location.

17. The apparatus of claim 15, wherein the vehicle is configured to deliver water to the apparatus.
